(19) United States
(12) Patent Application Publication
(10) Pub. No.: US 2019/0067833 A1
(43) Pub. Date: Feb. 28, 2019

(54) ARRAY ANTENNA

(71) Applicant: TOYOTA JIDOSHA KABUSHIKI KAISHA, Toyota-shi (JP)

(72) Inventor: Yoshiaki MINAMI, Gotemba-shi (JP)

(73) Assignee: TOYOTA JIDOSHA KABUSHIKI KAISHA, Toyota-shi (JP)

(21) Appl. No.: 16/044,605

(22) Filed: Jul. 25, 2018

(30) Foreign Application Priority Data
Aug. 31, 2017 (JP) 2017-167169

(51) Int. Cl. H01Q 21/06; H01Q 13/08; H01Q 21/00

(52) U.S. Cl. CPC H01Q 21/06; H01Q 21/0075; H01Q 13/08

(57) ABSTRACT

An array antenna is provided with: a feeding line; and a plurality of radiating elements, wherein the feeding line has a part whose length corresponds to (2n−1)/4 (wherein n is a natural number) times as long as a wavelength, in electrical length, from a reflection end of said feeding line, wherein the part is wider than another part that is on an input end side with respect to the part.

### CROSS-REFERENCE TO RELATED APPLICATIONS

This application is based upon and claims the benefit of priority of the prior Japanese Patent Application No. 2017-167169, filed on Aug. 31, 2017, the entire contents of which are incorporated herein by reference.

### BACKGROUND

### 1. Technical Field

Embodiments of the present disclosure relate to an array antenna.

### 2. Description of the Related Art

For this type of antenna, for example, there is proposed a planar array antenna having a feeding strip line, which linearly extends, and 10 radiating antenna elements, which project perpendicularly from the line (refer to Japanese Patent Application Laid Open No. 2001-111330 (Patent Literature 1)).

The array antenna in a shape similar to that of the feeding strip line disclosed in the Patent Literature 1 has relatively large radio wave radiation or emission from a reflection end. The radio wave radiation from the reflection end is unnecessary radio wave radiation coming from a part other than the radiating antenna elements. If the radio wave radiation from the reflection end is relatively large, a side lobe level increases, which influences directivity of the array antenna. This increases erroneous detection and noise, resulting in a reduction in a detection performance of the array antenna.

### SUMMARY

In view of the aforementioned problems, it is therefore an object of embodiments of the present disclosure to provide an array antenna that can suppress the radio wave radiation from the reflection end.

The above object of embodiments of the present disclosure can be achieved by an array antenna provided with: a feeding line; and a plurality of radiating elements, wherein the feeding line has a part whose length corresponds to (2n−1)/4 (wherein n is a natural number) times as long as a wavelength, in electrical length, from a reflection end of said feeding line, wherein the part is wider than another part that is on an input end side with respect to the part.

### BRIEF DESCRIPTION OF THE DRAWINGS

FIG. 1A is a plan view illustrating an array antenna according to an embodiment;

FIG. 1B is a plan view illustrating an array antenna according to the embodiment;

FIG. 2 is an enlarged view illustrating a reflection end of the array antenna according to the embodiment;

FIG. 3A is a plan view illustrating an array antenna according to a comparative example;

FIG. 3B is a plan view illustrating an array antenna according to the comparative example;

FIG. 4 is a diagram illustrating an example of a characteristic of the array antenna according to the comparative example;

FIG. 5 is a diagram illustrating another example of the characteristic of the array antenna according to the comparative example;

FIG. 6A is a diagram illustrating an example of a relation between a shape and a characteristic in the vicinity of the reflection end of the array antenna;

FIG. 6B is a diagram illustrating an example of a relation between a shape and a characteristic in the vicinity of the reflection end of the array antenna;

FIG. 6C is a diagram illustrating an example of a relation between a shape and a characteristic in the vicinity of the reflection end of the array antenna;

FIG. 7 is an enlarged view illustrating a reflection end of an array antenna according to a first modified example of the embodiment;

FIG. 8 is an enlarged view illustrating a reflection end of an array antenna according to a second modified example of the embodiment; and

FIG. 9 is an enlarged view illustrating a reflection end of an array antenna according to a third modified example of the embodiment.

### DETAILED DESCRIPTION OF THE EMBODIMENTS

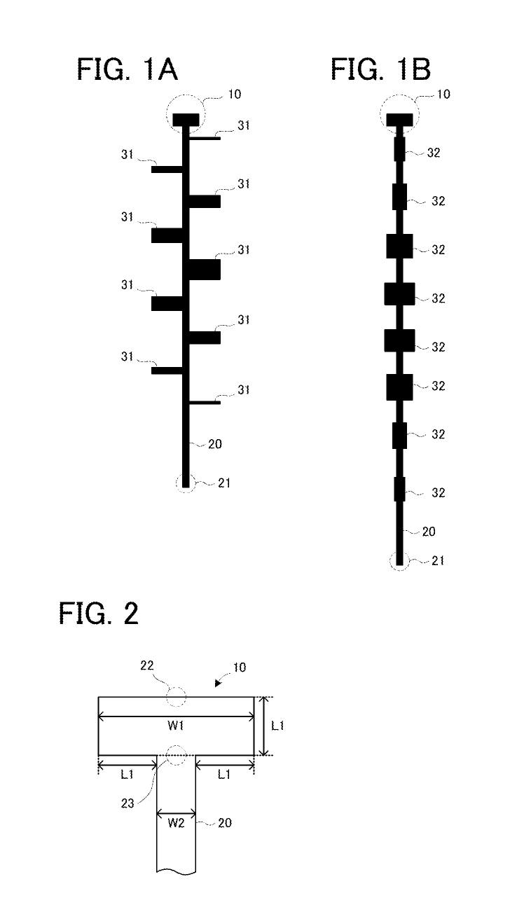

An array antenna according to an embodiment of the present disclosure will be explained with reference to FIG. 1A to FIG. 6C.

(Configuration)

The array antenna according to the embodiment will be explained with reference to FIG. 1A and FIG. 1B. FIG. 1A and FIG. 1B are plan views illustrating the array antenna according to the embodiment. FIG. 1A illustrates a horizontal polarization array antenna according to the embodiment. FIG. 1B illustrates a vertical polarization array antenna according to the embodiment.

As illustrated in FIG. 1A, the horizontal polarization array antenna is provided with a feeding line 20, which linearly extends, and a plurality of radiating elements 31, which project and branch in a direction that crosses a direction of the feeding line 20 extending. In the same manner, as illustrated in FIG. 1B, the vertical polarization array antenna is provided with the feeding line 20, which linearly extends, and a plurality of radiating elements 32, which are arranged at predetermined intervals along the feeding line 20. The feeding line 20 is preferably a micro strip line.

A part of an electric power inputted to an input end 21 of the feeding line 20 is successively coupled to each of the radiating elements 31 or 32 and is radiated or emitted; namely, a radio wave is radiated from each of the radiating elements 31 or 32. Another part of the electric power inputted to the input end 21, i.e., a residual power, reaches an open-type reflection end of the feeding line 20. An electric power reflected on the reflection end is again successively coupled to each of the radiating elements 31 or 32 and is radiated.

The array antenna according to the embodiment is characterized by a shape of a part 10 including the reflection end. Hereinafter, the shape of the part 10 will be explained without clarifying a distinction between the horizontal polarization array antenna and the vertical polarization array antenna.

The part 10 will be explained with reference to FIG. 2. FIG. 2 is an enlarged view illustrating the reflection end of the array antenna according to the embodiment.

In FIG. 2, the part 10 has a length corresponding to one-quarter times as long as a wavelength, in electrical length, as viewed from a connector 23 for coupling to the feeding line 20. In other words, the part 10 has a length corresponding to one-quarter of the wavelength, in electrical length, from a reflection end 22 of the feeding line 20. As illustrated in FIG. 2, a width W1 of the part 10, i.e., a distance in the direction that crosses the direction of the feeding line 20 extending, is greater than a width W2 of the feeding line 20, which is on the input end 21 side with respect to the part 10.

A projection amount to the left of the part 10 from a left end of the feeding line 20 and a length of the part 10 in the direction of the feeding line 20 extending are equally L1. In the same manner, a projection amount to the right of the part 10 from a right end of the feeding line 20 and the length of the part 10 in the direction of the feeding line 20 extending are equally L1.

### COMPARATIVE EXAMPLE

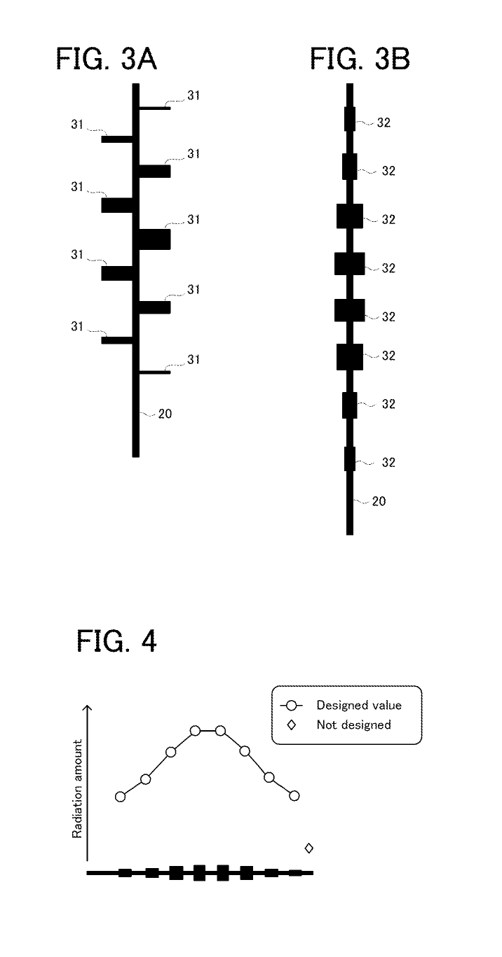

Here, using an array antenna according to a comparative example, the meaning of the shape of the part 10 will be explained. In the array antenna according to the comparative example, as illustrated in FIG. 3A and FIG. 3B, a width of a part in the vicinity of a reflection end of the feeding line 20, i.e., a part corresponding to the part 10, is equal to a width of the feeding line 20, which is on the input end 21 side with respect to the relevant part.

As described above, the residual power of the electric power inputted to the input end 21 reaches the reflection end of the feeding line 20. A part of the residual power that reaches the reflection end is reflected on the reflection end, and another part of the residual power is radiated from the reflection end. Here, in particular, a voltage of the reflection end relatively increases on the open-type reflection end, and there is a relatively strong electric field between the reflection end and a not-illustrated bottom board. As a result, a relatively large amount of electric power is radiated from the reflection end.

Specifically, for example, in the vertical polarization array antenna, other than a radiation amount of the electric power from each radiating element 32 (refer to a white circle indicating a “designed value” in FIG. 4), there is radiation from the reflection end (refer to a white rhombus indicating “not designed” in FIG. 4). Here, it is assumed that there is radiation with 20% of a maximum value in an amplitude value (with 4% in the electric power) from the reflection end.

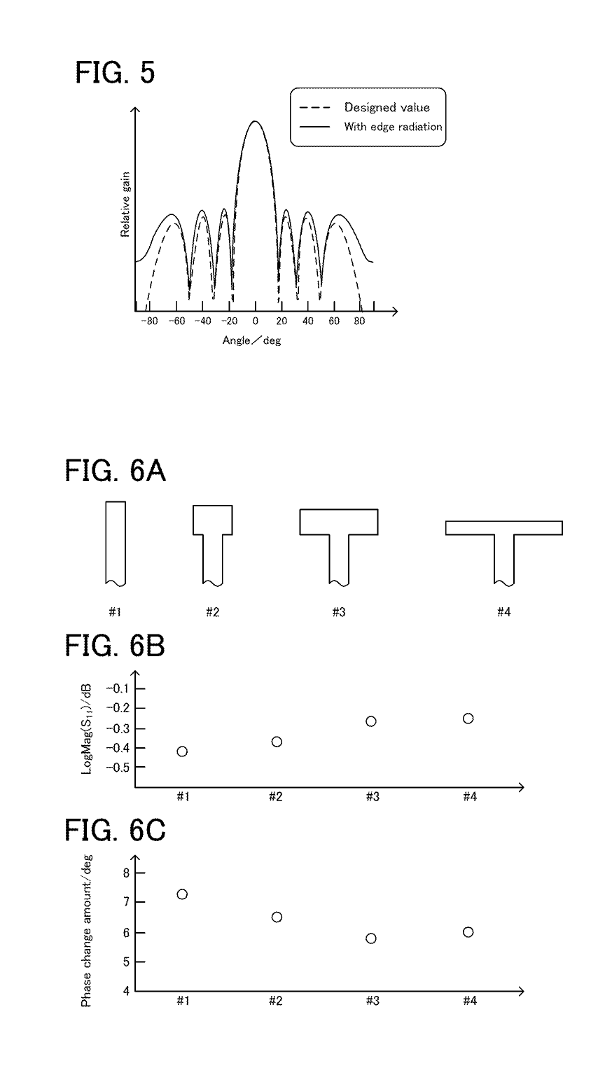

The radiation of the electric power from the reflection end influences radiation directivity of the array antenna. Specifically, for example, as illustrated in FIG. 5, the radiation directivity when there is the radiation of the electric power from the reflection end (refer to a solid line indicating “with edge radiation” in FIG. 5) has a higher side lobe level than the radiation directivity when there is no radiation of the electric power from the reflection end (refer to a dashed line indicating a “designed value” in FIG. 5). It is known that a side lobe may cause interference from surroundings and may increase noise. Thus, in the array antenna according to the comparative example, erroneous detection and noise are increased, resulting in a reduction in detection performance of the array antenna.

The following effect can be obtained because the feeding line 20 has the aforementioned part 10; namely, the electric power propagated through the feeding line 20 from the input end 21 to the reflection end 22 is reflected at two positions, which are the reflection end 22 and the connector 23 of the part 10 on the input end 21 side. This is because a characteristic impedance changes, with the connector 23 as a boundary. A part of the electric power, i.e., the residual power, is reflected on the connector 23. Thus, the electric power that reaches the reflection end 22 is reduced. As a result, an amount of the electric power radiated from the reflection end 22 is suppressed.

The reflection of the electric power on the open-type reflection end 22 is open-end reflection. Thus, a phase of a reflected wave does not change from a phase of an incident wave. On the other hand, the reflection of the electric power on the connector 23 is fixed-end reflection. This is because the part 10 has a lower characteristic impedance than that of the feeding line 20. Thus, the phase of the reflected wave reflected on the connector 23 is shifted by 180 degrees from the phase of the incident wave; namely, the phase is inverted.

Here, a path difference between the electric power reflected on the reflection end 22 and the electric power reflected on the connector 23 is one-half times as long as the wavelength, i.e., “λ/2”, in electrical length. This is because an electrical length of the part 10 as viewed from the connector 23 corresponds to λ/4, and λ/2 in a round way. Thus, the electric power reflected on the reflection end 22 and the electric power reflected on the connector 23 are in-phase and intensify each other. As a result, deterioration in a reflection characteristic caused by the part 10 does not occur.

(Technical Effect)

A technical effect of the array antenna according to the embodiment will be explained with reference to FIG. 6A to FIG. 6C. FIG. 6A to FIG. 6C are diagrams illustrating an example of a relation between the shape and the characteristic in the vicinity of the reflection end of the array antenna. In FIG. 6A, a shape indicated by a mark “#1” corresponds to the array antenna according to the comparative example described above. A shape indicated by a mark “#3” corresponds to the shape of the part 10 of the array antenna according to the embodiment.

FIG. 6B illustrates an example of a result of reflection characteristic measurement performed at a frequency of 76.5 GHz (gigahertz). As is seen in FIG. 6B, as the width in the vicinity of reflection end of the feeding line (corresponding to the “width W1” in FIG. 2) increases, the reflection increases. In other words, as the width in the vicinity of reflection end of the feeding line increases, the amount of the electric power radiated from the reflection end is reduced.

FIG. 6C illustrates an example of a result of measurement of a phase change amount of the reflected wave when the frequency is changed in a range of 76 GHz to 77 GHz. As illustrated in FIG. 6C, the phase change amount is reduced if the width in the vicinity of reflection end of the feeding line is increased, but the phase change amount starts to increase if the width is excessively increased. Here, the reduced phase change amount means that the bandwidth of the array antenna can be widen.

According to the array antenna in the embodiment, it is possible to suppress the amount of the electric power radiated from the reflection end 22 of the feeding line 20. In addition, it is possible to prevent the deterioration in the reflection characteristic caused by the part 10, by setting the electrical length of the part 10 as viewed from the connector 23 to λ/4, as described above. Moreover, as illustrated in FIG. 6C, the bandwidth of the array antenna can be widen.

The width W1 of the part 10 is not limited to the width illustrated in FIG. 2, as long as it is greater than the width W2. As illustrated in FIG. 6B, if the width W1 is greater than the width W2, in comparison with otherwise (refer to “#1” in FIG. 6A), the amount of the electric power radiated from the reflection end 22 can be suppressed. The width W1 of the part 10 is desirably longer than the length of the part 10 in the direction of the feeding line 20 extending. If the width W1 is longer than the length of the part 10 in the direction of the feeding line 20 extending, in comparison with otherwise (refer to “#2” in FIG. 6A), the amount of the electric power radiated from the reflection end 22 can be suppressed (refer to FIG. 6B), and the phase change amount can be also suppressed (refer to FIG. 6C).

In view of the effect of suppressing the amount of the electric power radiated from the reflection end 22 and the effect of widening the bandwidth of the array antenna, it can be said that the shape of the array antenna in the vicinity of the reflection end is desirably the shape indicated by the mark “#3” in FIG. 6A, i.e., the shape of the part 10 in FIG. 2 (refer to FIG. 6B and FIG. 6C).

### FIRST MODIFIED EXAMPLE

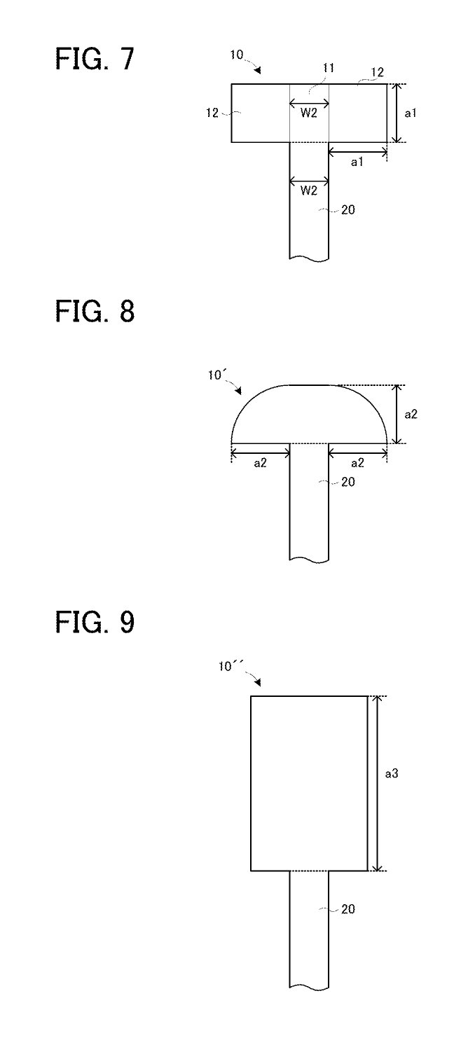

A first modified example of the array antenna according to the embodiment described above will be explained with reference to FIG. 7. FIG. 7 is an enlarged view illustrating a reflection end of an array antenna according to the first modified example of the embodiment.

The part 10 may include, as illustrated in FIG. 7, a first part 11 with the width W2 and a second part 12 (e.g., a patch) arranged to sandwich the first part 11 therebetween. In an example illustrated in FIG. 7, the second part 12 is a square with a side of a1 (=L1).

### SECOND MODIFIED EXAMPLE

A second modified example of the array antenna according to the embodiment described above will be explained with reference to FIG. 8. FIG. 8 is an enlarged view illustrating a reflection end of an array antenna according to the second modified example of the embodiment.

The part 10 according to the embodiment may be formed to partially have a circular arc outer edge, as is a part 10′ illustrated in FIG. 8. An electric current propagated or flowing through the feeding line 20 concentrates on a side end of the feeding line 20. The electric current flowing on the side end radially spreads in a part in the vicinity of the reflection end, which is the part 10′ here. A shape of the part 10′ reflects a current distribution radially spreading in the part 10′.

In the part 10′, a radius (i.e., a2) of a part projecting to the left of the part 10′ from a left edge of the feeding line 20 is desirably a radius corresponding to λ/4 in electrical length as the part 10′ is viewed from the connector. In the same manner, in the part 10′, a radius (i.e., a2) of a part projecting to the right of the part 10′ from a right edge of the feeding line 20 is desirably a radius corresponding to λ/4 in electrical length as the part 10′ is viewed from the connector.

### THIRD MODIFIED EXAMPLE

A third modified example of the array antenna according to the embodiment described above will be explained with reference to FIG. 9. FIG. 9 is an enlarged view illustrating a reflection end of an array antenna according to the third modified example of the embodiment.

In the part 10 according to the embodiment described above, as in a part 10″ illustrated in FIG. 9, a length (i.e., a3) in the direction of the feeding line 20 extending may be a length corresponding to 3λ/4 in electrical length as the part 10″ is viewed from the connector. In this case, the path difference between the electric power reflected on the reflection end 22 (refer to FIG. 2) and the electric power reflected on the connector 23 (refer to FIG. 2) is two-third times as long as the wavelength, i.e., “3λ/2”, in electrical length. Thus, the electric power reflected on the reflection end 22 and the electric power reflected on the connector 23 are in-phase and intensify each other. Therefore, according to this modified example, it is possible to suppress the amount of the electric power radiated from the reflection end 22 of the feeding line 20, and it is also possible to prevent deterioration in the reflection characteristic caused by the part 10″.

Various aspects of embodiments of the present disclosure derived from the embodiment and modified examples explained above will be explained hereinafter.

An array antenna according to an aspect of embodiments of the present disclosure is provided with: a feeding line; and a plurality of radiating elements, wherein the feeding line has a part whose length corresponds to (2n−1)/4 (wherein n is a natural number) times as long as a wavelength, in electrical length, from a reflection end of said feeding line, wherein the part is wider than another part that is on an input end side with respect to the part.

The “electrical length” is a length based on an electrical phase change amount, and a length in which the phase changes by 360 degrees is equivalent to one wavelength.

By setting the line width of the part to be wider than that of the another part, an electric power propagated through the feeding line to the reflection end is reflected at two positions, which are the reflection end of the feeding line and an end of the part on the input end side. Thus, the electric power that reaches the reflection end of the feeding line is reduced. As a result, radiation of the electric power from the reflection end is reduced. According to the array antenna, it is therefore possible to suppress the radiation of the electric power (or radio wave) from the reflection end.

The reflection of the electric power on the reflection end is open-end reflection. Thus, a phase of a reflected wave does not change from a phase of an incident wave. On the other hand, the reflection of the electric power on the end of the part on the input end side is fixed-end reflection. This is because the part has a lower characteristic impedance than that of the another part. Thus, the phase of the reflected wave is shifted by 180 degrees from the phase of the incident wave; namely, the phase is inverted. A path difference between the electric power reflected on the reflection end and the electric power reflected on the end of the part on the input end side is (2n−1)/2 times as long as the electrical length. This is because a length of the part in the direction of the feeding line extending corresponds to (2n−1)/4 times as long as the wavelength, in electrical length, as the part is viewed from the end. Thus, the electric power reflected on the reflection end and the electric power reflected on the end of the part on the input end side are in-phase and intensify each other. It is possible to prevent deterioration in the reflection characteristic caused by a shape of the part, by setting the length of the part in the direction of the feeding line extending to be (2n−1)/4 times as long as the wavelength, in electrical length, as the part is viewed from the end of the part.

In an array antenna according to another aspect of embodiments of the present disclosure, a length of the part in a direction that crosses a direction of said feeding line extending is greater than a length of the part in the direction of said feeding line extending. By virtue of such a configuration, it is possible to reduce an electric power that reaches the reflection end of the feeding line. As a result, it is possible to further reduce the radiation of the electric power from the reflection end.

In an array antenna according to another aspect of embodiments of the present disclosure, as planarly viewed from above the array antenna, the part includes a first part having the same line width as that of the another part, and a second part arranged to sandwich the first part therebetween. By virtue of such a configuration, it is possible to relatively easily form the part.

In an array antenna according to another aspect of embodiments of the present disclosure, the feeding line is a micro strip line.

The present disclosure may be embodied in other specific forms without departing from the spirit or essential characteristics thereof. The present embodiments and examples are therefore to be considered in all respects as illustrative and not restrictive, the scope of the disclosure being indicated by the appended claims rather than by the foregoing description and all changes which come in the meaning and range of equivalency of the claims are therefore intended to be embraced therein.

What is claimed is:

1. An array antenna comprising: a feeding line; and a plurality of radiating elements, wherein
said feeding line has a part whose length corresponds to (2n−1)/4 (wherein n is a natural number) times as long as a wavelength, in electrical length, from a reflection end of said feeding line, wherein the part is wider than another part that is on an input end side with respect to the part.

2. The array antenna according to claim 1, wherein a length of the part in a direction that crosses a direction of said feeding line extending is greater than a length of the part in the direction of said feeding line extending.

3. The array antenna according to claim 1, wherein as planarly viewed from above the array antenna, the part includes a first part having the same line width as that of the another part, and a second part arranged to sandwich the first part therebetween.

4. The array antenna according to claim 1, wherein said feeding line is a micro strip line.

5. The array antenna according to claim 2, wherein as planarly viewed from above the array antenna, the part includes a first part having the same line width as that of the another part, and a second part arranged to sandwich the first part therebetween.

6. The array antenna according to claim 2, wherein said feeding line is a micro strip line.

7. The array antenna according to claim 3, wherein said feeding line is a micro strip line.
